(19) United States
(12) Patent Application Publication
(10) Pub. No.: US 2018/0281500 A1
(43) Pub. Date: Oct. 4, 2018

(54) SYSTEM FOR CLEANING FLEXOGRAPHIC PRINTING PLATES

(71) Applicant: GLUNZ & JENSEN, Ringsted (DK)

(72) Inventors: Joachim SPIES, Ringsted (DK); Leo BACH ANDERSEN, Ringsted (DK); Jan KRISTOFFERSEN, Ringsted (DK); Steven MOELLER OLSEN, Ringsted (DK)

(21) Appl. No.: 15/764,184

(22) PCT Filed: Sep. 28, 2016
(86) PCT No.: PCT/DK2016/050312

§ 371 Date: Mar. 28, 2018

(30) Foreign Application Priority Data
Sep. 28, 2015 (DK) PA 2015 70614

(51) Int. Cl. B41N 3/00

(52) U.S. Cl. CPC B41N 3/006

(57) ABSTRACT

There is provided a system or apparatus for washing out flexographic printing plates. The system is presented in two distinct embodiments or aspects. In one embodiment the system is provided with a large number of rotating brushes which are at least partly immersed in a liquid bath. The second embodiment is based on a flat brush with an eccentric suspension

### FIELD OF THE INVENTION

The present invention relates to a system or apparatus for washing out flexographic printing plates. The system is provided in two distinct embodiments or aspects. In one embodiment the system is provided with a large number of rotating brushes which are at least partly immersed in a liquid bath. The second embodiment is based on a flat brush with an eccentric suspension.

### BACKGROUND OF THE INVENTION

In known apparatuses the printing plate to be treated contacts the liquid contained in a vessel, of which the wash-out quality steadily decreases as a consequence of the use of the active contents of the liquid and the pollution of the liquid by particles washed out or dissolved from the plates to be treated. Consequently this liquid has to be changed regularly. As a result thereof the quality of the liquid varies considerably so that it is possible that the plate to be treated is treated with a liquid, which is used and polluted considerably and that pollutions stay back on the plate thus treated. The quality of the delivered plates thus varies considerably.

In some known devices the printing plates are pulled through the device having rotating brushes to remove the photopolymers not polymerized during a previous exposure so that, depending on the design of the printing plate, at the end of the washing out process a positive or negative image remains in the form of relief on the printing plate.

During the process a certain fouling of the printing plates is unavoidable. Dirt particles adhering to the printing plates eventually lead to an accumulation of dirt particles on the printing cylinders, or a deposit of particles inside the printing relief, which may reduce the accuracy of the mounting of the printing plates on the printing cylinders and/or directly impacts the quality of the printed image. In addition, conventional brush-based processing suffers from substantially increased polymer and/or monomer concentration locally in the area where brush action is carried out. Such locally increased polymer/monomer concentration causes locally high viscosity and locally high saturation of the liquid, thus causing reduction of wash-out efficiency on the plate.

U.S. Pat. No. 4,952,961 discloses a machine for the treatment of printing plates which includes a plurality of rotating brushes of substantially cylindrical shape, over which a support table is slid in the longitudinal and transverse direction with a substantially random motion. The plate to be treated is secured under this support table, so that it is brushed by said cylindrical brushes. Also, the brushes are partially immersed in the liquids required for the treatment, solvents in particular, which are contained in suitable containers arranged under the brushes.

U.S. Pat. No. 4,536,909 discloses an apparatus for treating flexible printing plates produced by a photochemical method, wherein the upper rollers of the first four pairs of rollers are covered with velour and the lower rollers of these pairs of rollers and both the rollers of the fifth pair of rollers are covered with a textile fabric. With this apparatus it is possible to continuously wash out and clean even flexible printing plates which are very tacky after exposure and have a high relief image.

However, known systems cannot perfectly remove the non-polymerized portions, and in particular do not provide an even brushing of all the points of the surface and the relief of the printing plate to be treated. Moreover, known systems are complicated and bulky with high costs for manufacturing, maintenance and storing.

Therefore the object of the present invention is to provide a system free from said drawbacks. This object is achieved by means of a system for the treatment of printing plates in accordance with the claims.

### SUMMARY OF THE INVENTION

Thanks to the present invention all of the non-polymerized portions from printing plates may be removed. Moreover, it is possible to brush evenly the whole surface of the printing plate to be treated, without the risk of obtaining plate areas brushed differently from other areas.

According to one aspect of the invention there is provided a system for treating printing plates with a liquid, comprising:
a vessel containing the liquid for cleaning the printing plates;
means for conveying the printing plates to be treated through the liquid;
a structure rotatably supporting a plurality of brushes of substantially cylindrical shape and provided with sets of bristles attached to a substantially flat support of each brush, said brushes having their shafts orthogonal to the printing plates to be treated, said brushes submerged at least partially in the liquid,
   characterized in that at least half of the sets of bristles of said brushes are angled 50-90 degrees, preferably 70-85 degrees, and more preferably 80-85 degrees, relative to said flat support. Preferably, the at least half of the sets of bristles of said brushes are radially angled. Importantly a much improved cleaning is achieved when the brushes are angled 70-85 degrees.

In a preferred embodiment nozzles are provided in the center of the brushes enabling delivery of cleaning liquid to the zones in which the brushes treat the printing plates. This particular nozzle position ensures constant supply of fresh liquid, whilst it due to centrfigual force is rapidly transported away from the wash-out zone.

The bristles may be made from any suitable material but preferably made from Nylon or polypropylene.

According to a second aspect of the invention there is provided a system for treating printing plates with a liquid, comprising:
a vessel containing the liquid for cleaning the printing plates;
means for conveying the printing plates to be treated through the liquid;
a support structure supporting a plurality of sets of bristles attached to support structure, said bristles submerged at least partially in the liquid and arranged so that the bristles touches the printing plate to be treated;
   characterized in that
at least half of the sets of bristles are angled 50-90 degrees, preferably 70-85 degrees, and more preferably 80-85 degrees, relative to support structure, and
said support structure is eccentrically pivoted onto a support frame, so that it can be moved by a motor with an orbital motion along a plane parallel to the printing plate to be treated.
the support frame can be segmented, allowing individual drive of groups of support structures. Importantly a much improved cleaning is achieved when the brushes are angled 70-85 degrees.

Preferably, nozzles are provided in the support structure between the bristles enabling delivery of cleaning liquid to the zones in which the bristles treat the printing plates.

It is preferred that the sets of bristles are attached to support structure so that adjacent sets of bristles in at least one axis are angled relative to each other in an angle of 50-90 degrees; said axis is either transverse or parallel to the axis along which the printing plates are to be conveyed.

Finally, the system according to the present invention has an advantageously reduced complexity and bulkiness, thanks to the particular arrangement of the brushes, support table and mechanisms for the movement thereof. Further advantages and characteristics of the system according to the present invention will be clear to those skilled in the art from the following detailed and non-limiting description of an embodiment thereof, with reference to the annexed drawings.

### BRIEF DESCRIPTION OF THE DRAWINGS

FIG. 1 shows a sectional side view of the brush system according to the first aspect of the present invention.

FIG. 2 shows a partial top plan view, slightly inclined, of the system of FIG. 1.

FIG. 3 shows a top view, slightly inclined, of the brush system according to the second aspect of the present invention.

FIG. 4 shows a bottom view, slightly inclined, of the system of FIG. 3.

### DETAILED DESCRIPTION OF THE INVENTION

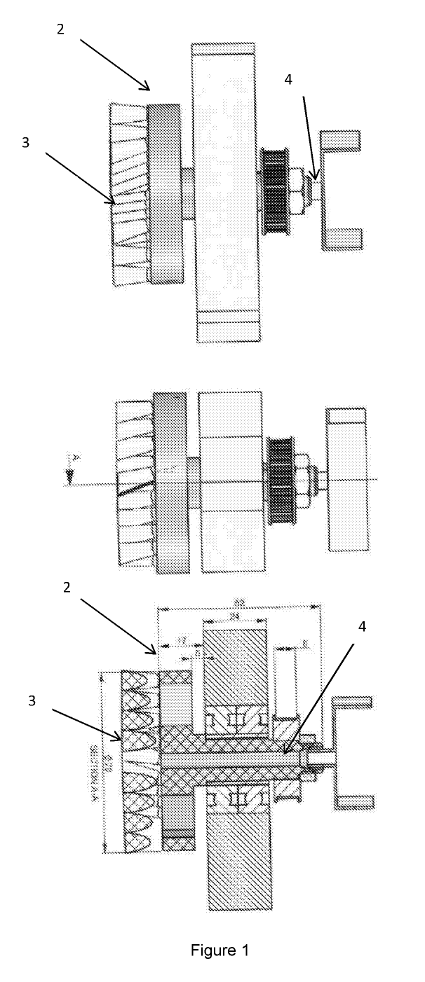

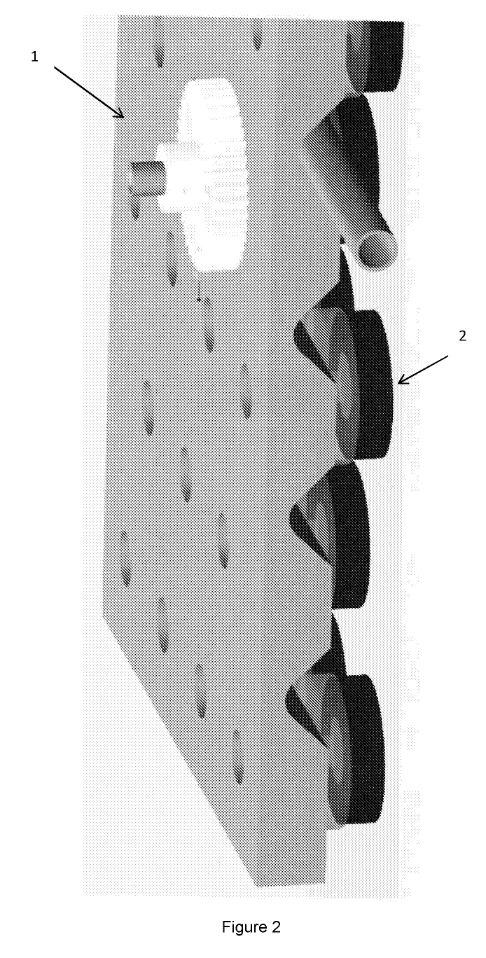

Referring to FIGS. 1 and 2 there is shown a system for treating printing plates according to the first aspect of the present invention. There is shown the structure (1) rotatably supporting a plurality of brushes (2) of substantially cylindrical shape and provided with sets of bristles (3) attached to a substantially flat support of each brush, said brushes having their shafts (4) orthogonal to the printing plates to be treated. As can be seen from FIG. 2 the bristles (3) are angled about 75 degrees relative to said flat support.

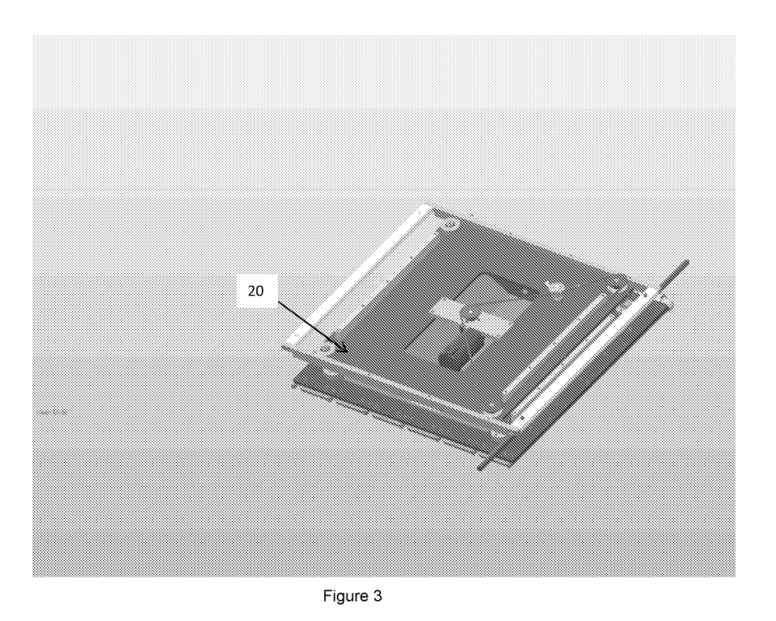

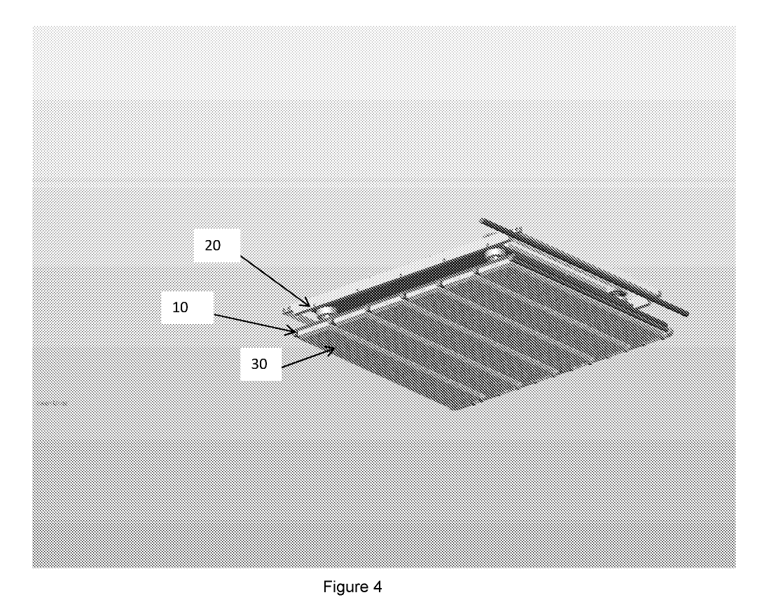

Referring to FIGS. 3 and 4 there is shown a system for treating printing plates according to the second aspect of the present invention. Specifically there is shown a support structure (10) supporting a plurality of sets of bristles (30) attached to the support structure (10). The sets of bristles are angled about 75 degrees relative to support structure (10), which is eccentrically pivoted onto a support frame (20) so that it can be moved by a motor (not shown) with an orbital motion along a plane parallel to the printing plate to be treated.

1. A system for treating printing plates with a liquid, comprising:
a vessel containing the liquid for cleaning the printing plates;
means for conveying the printing plates to be treated through the liquid;
a structure rotatably supporting a plurality of brushes of substantially cylindrical shape and provided with sets of bristles attached to a substantially flat support of each brush, said brushes having their shafts orthogonal to the printing plates to be treated, said brushes submerged at least partially in the liquid,
wherein at least half of the sets of bristles of said brushes are angled 50-85 degrees, such as 70-85 degrees, and more preferably 80-85 degrees, relative to said flat support.

2. The system according to claim 1, wherein the at least half of the sets of bristles of said brushes are radially angled.

3. The system according to claim 1, wherein nozzles are provided in the center of the brushes of substantially cylindrical shape enabling delivery of cleaning liquid to the zones in which the brushes treat the printing plates.

4. The system according to claim 1, wherein the bristles are made from Nylon or polypropylene.

5. The system according to claim 1, wherein brushes may be different in design and operation allowing individual drive, speed, pressure adjustment, and bristle type of the brushes.

6. A system for treating printing plates with a liquid, comprising:
a vessel containing the liquid for cleaning the printing plates;
means for conveying the printing plates to be treated through the liquid;
a support structure supporting a plurality of sets of bristles attached to support structure, said bristles submerged at least partially in the liquid and arranged so that the bristles touches the printing plate to be treated;
wherein
at least half of the sets of bristles are angled 50-90 degrees, such as 50-85 degrees or 70-85 degrees, and more preferably 80-85 degrees relative to support structure, and—said support structure is eccentrically pivoted onto a support frame, so that it can be moved by a motor with an orbital motion along a plane parallel to the printing plate to be treated.

7. The system according to claim 6, wherein nozzles are provided in the support structure between the bristles enabling delivery of cleaning liquid to the zones in which the bristles treat the printing plates.

8. The system according to claim 6, wherein the bristles are made from Nylon or polypropylene.

9. The system according to claim 6, wherein the sets of bristles are attached to support structure so that adjacent sets of bristles in at least one axis are angled relative to each other in an angle of 50-85 degrees.

10. The system according to claim 9, wherein the axis is transverse to the axis along which the printing plates are to be conveyed.

11. The system according to claim 9, wherein the axis is parallel to the axis along which the printing plates are to be conveyed.

12. The system according to claim 6, wherein the support structure is segmented, allowing individual drive, speed, pressure adjustment, and bristle type of the segments of the support structures.
